(19) United States
(12) Patent Application Publication
(10) Pub. No.: US 2014/0014710 A1
(43) Pub. Date: Jan. 16, 2014

(54) Method For Hermetically Joining Ceramic Materials Using Brazing Of Pre-Metallized Regions

(71) Applicant: Component Re-Engineering Compnay, Inc., (US)

(72) Inventors: Alfred Grant Elliot, Palo Alto, CA (US); Brent Donald Alfred Elliot, Cupertino, CA (US); Frank Balma, Los Gatos, CA (US); Richard Erich Schuster, Milpitas, CA (US); Dennis George Rex, Williams, OR (US); Alexander Veytser, Mountain View, CA (US); Michael Parker, Brentwood, CA (US); Jeff Cuhna, San Jose, CA (US)

(21) Appl. No.: 13/831,186

(22) Filed: Mar. 14, 2013

Related U.S. Application Data
(60) Provisional application No. 61/658,896, filed on Jun. 12, 2012.
(60) Provisional application No. 61/707,865, filed on Sep. 28, 2012.
(60) Provisional application No. 61/728,810, filed on Nov. 21, 2012.

(51) Int. Cl. C04B 37/00

(52) U.S. Cl. CPC C04B 37/00
USPC 228/121

(57) ABSTRACT

A method for the joining of ceramic pieces with a hermetically sealed joint comprising brazing a continuous layer of joining material between the two pieces. The ceramic pieces may be aluminum nitride and the pieces may be brazed with an aluminum alloy under controlled atmosphere. The ceramic pieces may be pre-metallized using a thin film sputtering technique which deposits aluminum, or an aluminum alloy, onto the joint interface areas. The joint material is adapted to later withstand both the environments within a process chamber during substrate processing, and the oxygenated atmosphere which may be seen within the shaft of a heater or electrostatic chuck.

### CROSS-REFERENCE TO RELATED APPLICATIONS

This application claims priority to U.S. Provisional Application No. 61/658,896 to Elliot et al., filed Jun. 12, 2012, which is hereby incorporated by reference in its entirety. This application claims priority to U.S. Provisional Application No. 61/707,865 to Elliot et al., filed Sep. 28, 2012, which is hereby incorporated by reference in its entirety. This application claims priority to U.S. Provisional Application No. 61/757,090 to Elliot et al., filed Jan. 25, 2013, which is hereby incorporated by reference in its entirety.

### BACKGROUND

1. Field of the Invention

The present invention relates to methods for joining together objects, and more particularly to brazing methods for joining ceramic objects.

2. Description of Related Art

The joining of ceramic materials may involve processes which require very high temperatures and very high contact pressures. For example, liquid phase sintering may be used to join ceramic materials together. In this type of manufacture, at least two drawbacks are seen. First, the hot pressing/sintering of a large, complex ceramic piece requires a large physical space within a very specialized process oven. Second, should a portion of the finished piece become damaged, or fail due to wear, there is no repair method available to disassemble the large piece. The specialized fixturing, high temperatures, and inability to disassemble these assemblies invariably leads to very high manufacturing costs.

Other processes may be geared towards strength, and may yield strong bonds between the pieces that, although structurally sufficient, do not hermetically seal the pieces. In some processes, diffusion bonding is used, which may take significant amounts of time, and may also alter the individual pieces such that they form new compounds near the joint. This may render them unfit for certain applications, and unable to be reworked or repaired and rejoined.

What is called for is a joining method for joining ceramic pieces at a low temperature and which provides a hermetic seal, and which allows for repairs.

### SUMMARY OF THE INVENTION

A method for the joining of ceramic pieces with a hermetically sealed joint comprising brazing a layer of joining material between the two pieces. One or both of the surfaces to be joined may be pre-metallized. The ceramic pieces may be aluminum nitride which have been pre-metallized with aluminum, and the pieces may be brazed with an aluminum alloy under controlled atmosphere. The joint material is adapted to later withstand both the environments within a process chamber during substrate processing, and the oxygenated atmosphere which may be seen within the interior of a heater or electrostatic chuck.

### BRIEF DESCRIPTION OF THE DRAWINGS

FIG. 1 is a SEM cross-sectional view of a joint according to some embodiments of the present invention.

FIG. 2 is a SEM cross-sectional view of a joint according to some embodiments of the present invention.

FIG. 3 is a SEM cross-sectional view of a joint according to some embodiments of the present invention.

FIG. 4 is a SEM cross-sectional view of a joint according to some embodiments of the present invention.

FIG. 5 is a SEM cross-sectional view of a joint according to some embodiments of the present invention.

FIG. 6 is a sketch of an illustrative view of a joined ceramic assembly according to some embodiments of the present invention.

FIG. 7 is a cross-sectional view of a joined ceramic assembly according to some embodiments of the present invention.

FIG. 8 is a perspective view of a ceramic piece with standoff mesas according to some embodiments of the present invention.

FIG. 9 is a cross-sectional view of a joint bridging different atmospheres according to some embodiments of the present invention.

FIG. 10 is a view representing the joint integrity of a joint.

FIG. 11 is a view representing the joint integrity of a joint.

### DETAILED DESCRIPTION

Some prior processes for the joining of ceramic materials required specialized ovens, and compression presses within the ovens, in order to join the materials. For example, with liquid phase sintering, two pieces may be joined together under very high temperatures and contact pressures. The high temperature liquid-phase sintering process may see temperatures in the range of 1700 C and contact pressures in the range of 2500 psi.

Other prior processes may utilize diffusion of a joining layer into the ceramic, and/or of the ceramic into the joining layer. In such processes, a reaction at the joint area may cause changes to the material composition of the ceramic in the area near the joint. This reaction may depend upon oxygen in the atmosphere to promote the diffusion reaction.

In contrast to the aforementioned diffusion processes, joining methods according to some embodiments of the present invention do not depend upon liquid phase sintering or diffusion.

In some applications where end products of joined ceramics are used, strength of the joint may not be the key design factor. In some applications, hermeticity of the joint may be required to allow for separation of atmospheres on either side of the joint. Also, the composition of the joining material may be important such that it is resistant to chemicals which the ceramic assembly end product may be exposed to. The joining material may need to be resistant to the chemicals, which otherwise might cause degeneration of the joint, and loss of the hermetic seal. The joining materials may also need to be of types of materials which do not negatively interfere with the processes later supported by the finished ceramic device.

Ceramic end products manufactured according to embodiments of the present invention may be manufactured with considerable energy savings relative to past processes. For example, the lower temperatures used for joining pieces with methods according the present invention, compared to the high temperatures of prior liquid phase sintering processes used for joining pieces, require less energy. In addition, there may be considerable savings in that the joining processes of the present invention do not require the specialized high temperature ovens, and the specialized fixturing and presses required to generate the high physical contact stresses, required for prior liquid phase sintering processes.

An example of a joined ceramic end product which may be manufactured according to embodiments of the present invention is the manufacture of a heater assembly used in semiconductor processing.

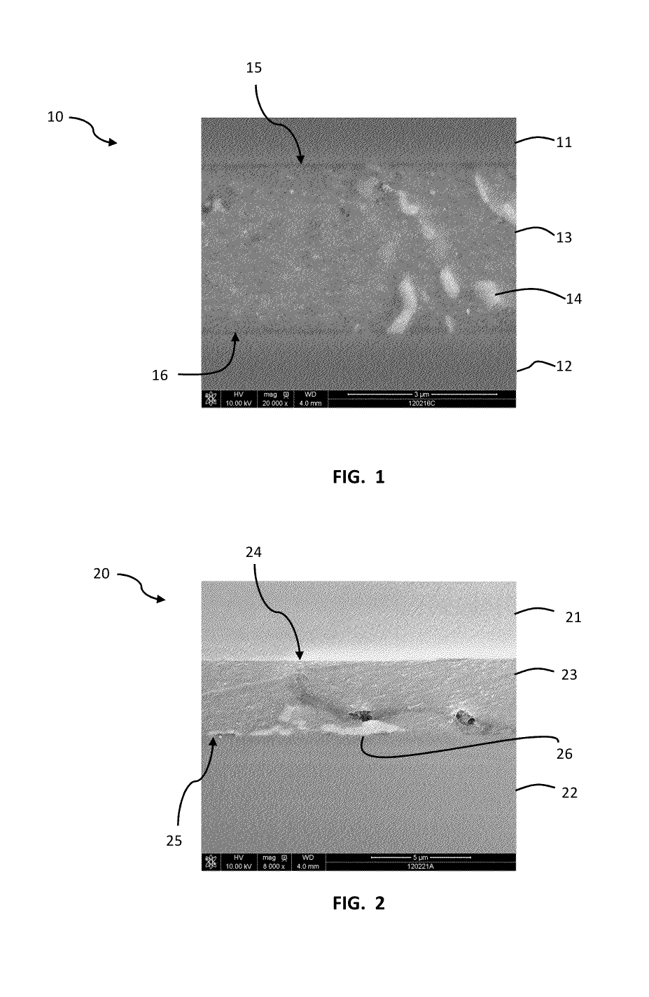

FIG. 1 is a view of a cross-section of a joint 10 according to some embodiments of the present invention. The image is a as seen through a Scanning Electron Microscope (SEM), and is taken at 20,000× magnification. A first ceramic piece 11 has been joined to a second ceramic piece 12 with a joining layer 13. In this exemplary embodiment, the first ceramic piece and second ceramic piece are made of mono-crystalline aluminum nitride (AlN). The joining layer began as aluminum foil with 0.4 Wt. % Fe. The joining temperature was 1200 C and was held for 120 minutes. The joining was done under a vacuum of 7.3×10E-5 Torr, with a physical contact pressure across the joint of approx. 290 psi during joining.

FIG. 1 illustrates the joint with an upper boundary 15 between the first ceramic piece 11 and the joining layer 13, and a lower boundary 16 between the joining layer 13 and the second ceramic piece 12. As seen at the boundary regions at 20,000× magnification, no diffusion is seen of the joining layer into the ceramic pieces. No evidence of reaction within the ceramics is seen. The boundaries do not show any evidence of voids and do indicate that there was complete wetting of the boundaries by the aluminum during the joining process. The bright spots 14 seen in the joining layer are an aluminum-iron compound, the iron being a residue from the foil used for the joining layer.

FIG. 2 is a view of a cross-section of a joint 20 according to some embodiments of the present invention. The view is as seen through a Scanning Electron Microscope (SEM), and is at 8,000× magnification. A first ceramic piece 21 has been joined to a second ceramic piece 22 with a joining layer 23. In this exemplary embodiment, the first ceramic piece and second ceramic piece are made of mono-crystalline aluminum nitride (AlN). The joining layer began as aluminum foil with 0.4 Wt. % Fe. The joining temperature was 900 C and was held for 15 minutes. The joining was done under a vacuum of 1.9×10E-5 Torr, with a minimal physical contact pressure across the joint during joining. The joining layer 23 illustrates that after the joining of the first ceramic piece 21 and the second piece 22 a residual layer of aluminum remains between the joined pieces.

FIG. 2 illustrates the joint with an upper boundary 24 between the first ceramic piece 21 and the joining layer 23, and a lower boundary 25 between the joining layer 23 and the second ceramic piece 22. As seen at the boundary regions at 8,000× magnification, no diffusion is seen of the joining layer into the ceramic pieces. No evidence of reaction within the ceramics is seen. The boundaries do not show any evidence of voids and do indicate that there was complete wetting of the boundaries by the aluminum during the joining process. The bright spots 26 seen in the joining layer contain Fe residue from the foil used for the joining layer.

FIGS. 1 and 2 illustrate joints according to embodiments of the present invention in which ceramics, such as mono-crystalline aluminum nitride, are joined with a joining layer of aluminum that achieved full wetting during the joining process. The joints show no evidence of diffusion of the joining layer into the ceramic, and no evidence of reaction areas within the joining layer or in the ceramic pieces. There is no evidence of a chemical transformation within the ceramic pieces or the joining layer. There is a residual layer of aluminum present after the joining process.

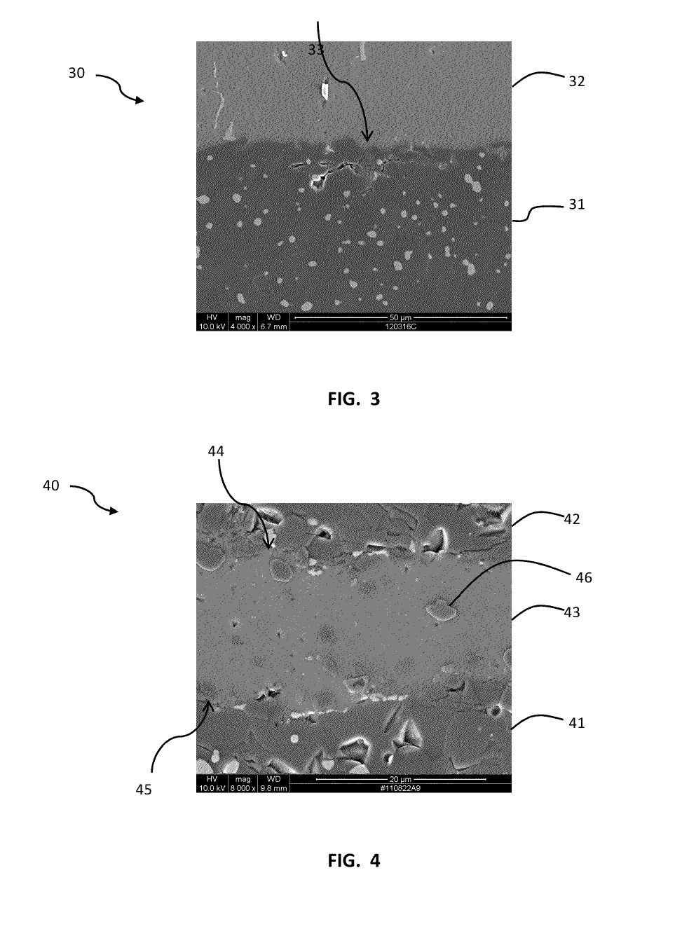

FIG. 3 illustrates a joint 30 according to embodiments of the present invention using a polycrystalline aluminum nitride ceramic. In FIG. 3, the joining layer 32 is seen joined to the lower ceramic piece 31. The view is as seen through a Scanning Electron Microscope (SEM), and is at 4,000× magnification. In this exemplary embodiment, the first ceramic piece is made of poly-crystalline aluminum nitride (AlN). The joining layer began as aluminum foil with 0.4 Wt. % Fe. The joining temperature was 1200 C and was held for 60 minutes. The joining was done under a vacuum of 2.4×10E-5 Torr, with a physical contact pressure across the joint during joining of approximately 470 psi.

In some embodiments, the poly-crystalline AlN, such as the ceramic seen in FIGS. 3-5, is comprised of 96% AlN and 4% Yttria. Such a ceramic may be used in industrial applications because during the liquid phase sintering used to manufacture the ceramic, a lower temperature may be used. The lower temperature process, in contrast to mono-crystalline AlN, reduces manufacturing energy consumption and costs of the ceramic. The poly-crystalline material may also have preferred properties, such as being less brittle. Yttria and other dopants, such as Sm2O3, are often used for manufacturability and tuning of material properties.

FIG. 3 illustrates the same lack of diffusion at the boundary 33 between the joining layer 32 and the first ceramic piece 31, which is a poly-crystalline AlN ceramic, as was seen with the mono-crystalline examples seen in FIGS. 1 and 2. Although the boundary 33 may appear to be somewhat rougher than seen in FIGS. 1 and 2, this is a result of a rougher original surface. No diffusion is seen along the boundary.

With a poly-crystalline AlN such as the 96% AlN-4% Yttria ceramic as seen in FIGS. 3-5, the ceramic presents grains of AlN which are interspersed with yttrium aluminate. When this ceramic is presented with aluminum, such as joining layers according to some embodiments of the present invention, at higher temperature such as above the liquidus temperature of Al, the Al brazing material may react with the yttrium aluminate resulting in the dislodging and release of some of the AlN grains at the surface of the ceramic.

FIG. 4 illustrates a joint 40 according to embodiments of the present invention using a polycrystalline aluminum nitride ceramic. In FIG. 4, the joining layer 43 is seen joining the upper ceramic piece 42 to the lower ceramic piece 41. The view is as seen through a Scanning Electron Microscope (SEM), and is at 8,000× magnification. In this exemplary embodiment, the first ceramic piece is made of poly-crystalline aluminum nitride (AlN). The joining layer began as aluminum foil with 99.8% Al. The joining temperature was 1120 C and was held for 60 minutes. The joining was done under a vacuum of 2.0×10E-5 Torr, with a minimal physical contact pressure across the joint during joining.

FIG. 4 illustrates some grains 46 of AlN within the joining layer 43. The grains 46 have migrated from the surface 44 of the upper ceramic piece 42 and/or the surface 45 of the lower ceramic piece 41. The AlN grains have been dislodged from the surface due to the aluminum of the joining layer having attacked the yttrium aluminate between the grains of the poly-crystalline AlN. The AlN grains themselves have not reacted with the aluminum joining layer, nor is any sign of diffusion of the aluminum into the AlN grains seen. The non-susceptibility of AlN to diffusion with aluminum under the conditions of processes according to embodiments of the present invention had been previously seen in the examples of mono-crystalline AlN of FIGS. 1 and 2, and is maintained in the poly-crystalline example of FIG. 4.

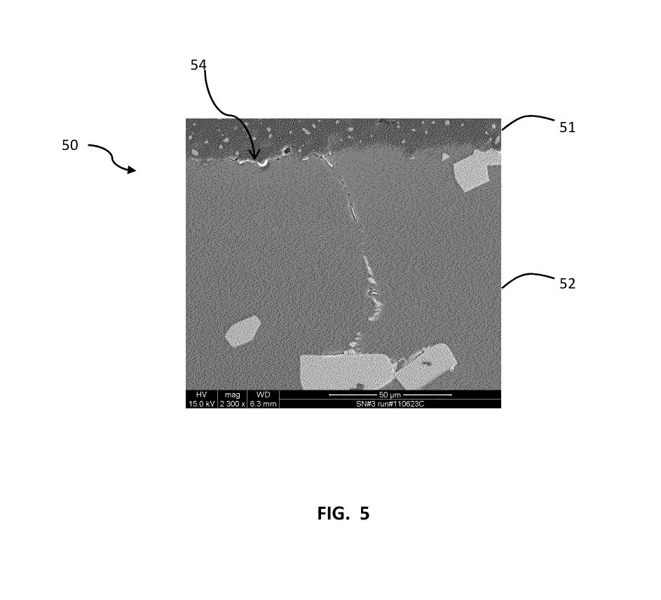

FIG. 5 illustrates a joint 50 according to embodiments of the present invention using a poly-crystalline aluminum nitride ceramic. In FIG. 5, the joining layer 52 is seen joined to the upper ceramic piece 51. The view is as seen through a Scanning Electron Microscope (SEM), and is at 2,300× magnification. In this exemplary embodiment, the first ceramic piece 51 is made of poly-crystalline aluminum nitride (AlN). The joining layer began as aluminum powder with 5 Wt. % Zr. The joining temperature was 1060 C and was held for 15 minutes. The joining was done under a vacuum of 4.0×10E-5 Torr, with a physical contact pressure across the joint during joining of approximately 8 psi.

The joints as seen in the examples of FIGS. 1-5 may be used in applications where a hermetically sealed joint between ceramic pieces is required. Although these joints were made at temperatures significantly lower than other prior processes, hermetically sealed joints may be made at even lower temperatures. Pre-metallizing ceramic pieces with a process such as sputtering a layer of aluminum onto the joint interface areas, allows the ceramic pieces to be joined at significantly lower temperatures.

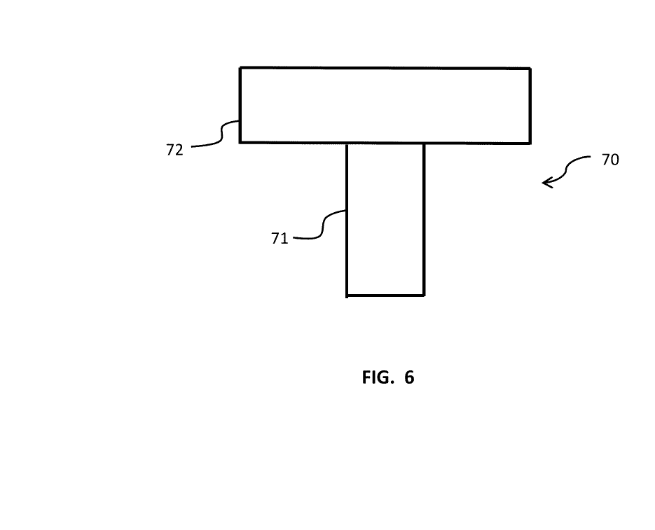

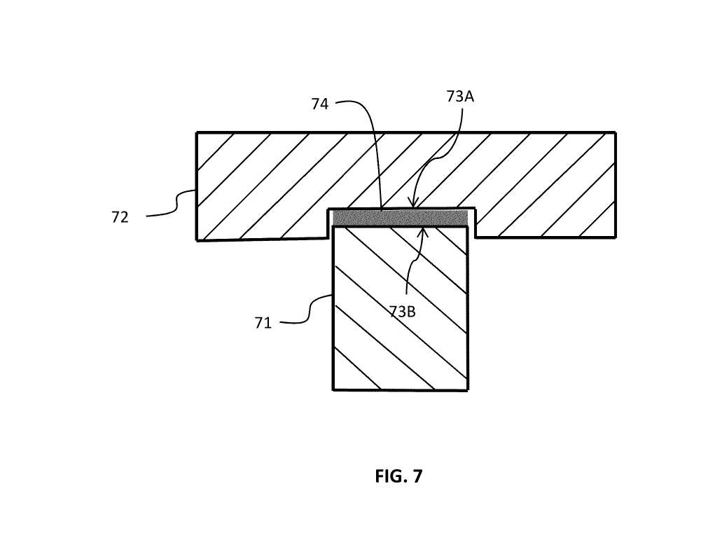

FIG. 6 illustrates an exemplary joined ceramic assembly 70. In some aspects, the joined ceramic assembly 70 is composed of a ceramic, such as aluminum nitride. Other materials, such as alumina, silicon nitride, silicon carbide or beryllium oxide, may be used. In some aspects, a first ceramic piece 72 may be aluminum nitride and a second ceramic piece 71 may be aluminum nitride, zirconia, alumina, or other ceramic. In some present processes, the joined ceramic assembly 70 components may first be manufactured individually in an initial process involving a process oven wherein the first piece 72 and the second piece 71 are formed.

FIG. 7 shows a cross section of an embodiment of a joint in which a first ceramic piece 72 is joined to a second ceramic piece 71, which may be made of the same or a different material, for example. A joining material, such as braze filler material 74, may be included, which can be selected from the combinations of braze materials or binders described herein and may be delivered to the joint according to the methods described herein. With respect to the joint depicted in FIG. 7, the first ceramic piece 72 is positioned such that a joint interface surface 73A of the first ceramic piece 72 abuts the second ceramic piece 71 along its joint interface surface 73,B with only the braze filler interposed between the surfaces to be joined. The thickness of the joint is exaggerated for clarity of illustration. In some embodiments, a recess may be included in one of the mating pieces, the first ceramic piece 72 in this example, which allows the other mating piece to reside within the recess.

The joint interface surface 73A of the first ceramic piece 72, and the joint interface area 73B of the second ceramic piece 71, may have a layer put on them prior to their introduction to the brazing process steps that join the first ceramic piece 72 to the second ceramic piece 71. In some embodiments, the first ceramic piece and the second ceramic piece are aluminum nitride. In some embodiments, the joint interfaces areas of the ceramic pieces have had a metal layer deposited using a thin film sputtering technique. The metal layer may be an aluminum layer. In an exemplary embodiment, both of the interface surfaces have a 2 micron layer of aluminum deposited using a thin film sputtering technique.

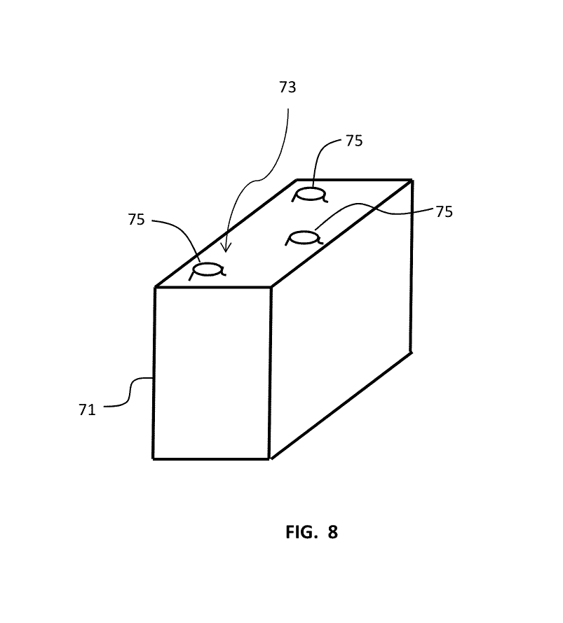

An embodiment as illustrated in FIG. 7 may include a plurality of standoffs adapted to maintain a minimum braze layer thickness. In some embodiments, as seen in FIG. 8, one of the ceramic pieces, such as the second ceramic piece 71, may utilize a plurality of standoffs mesas 75 on the end 73B of the second ceramic piece 71 which is to be joined to the first ceramic piece 72. The mesas 75 may be part of the same structure as the second ceramic piece 71, and may be formed by machining away structure from the piece, leaving the mesas. The mesas 75 may abut the end 73A of the first ceramic piece 72 after the joining process. In some embodiments, the mesas may be used to create a minimum braze layer thickness for the joint. In some embodiments, other methods may be used to establish a minimum braze layer thickness. In some embodiments, ceramic spheres may be used to establish a minimum braze layer thickness. In some embodiments, small spheres are used to maintain a minimum braze layer thickness. In some embodiments, the spheres may be 0.004 inches in diameter and made of Ytrria stabilized Zirconia.

In some embodiments, the braze layer material, prior to brazing, will be thicker than the distance maintained by the mesas or spheres between the shaft end and the plate. In some embodiments, the braze layer material, prior to brazing, will be equal to the distance maintained by the mesas or spheres between the shaft end and the plate. In some embodiments, the braze layer material, prior to brazing, will be slightly thinner than the distance maintained by the mesas or spheres between the shaft end and the plate. In some aspects, the joint thickness may be just slightly thicker than the dimension of the standoffs, or other minimum thickness determining device, as not quite all of the braze material may be squeezed out from between the standoffs and the adjacent interface surface. In some aspects, some of the aluminum braze layer may be found between the standoff and the adjacent interface surface. In some embodiments, the brazing material may be 0.006 inches thick prior to brazing with a completed joint minimum thickness of 0.004 inches. The brazing material may be aluminum with 0.4 Wt. % Fe.

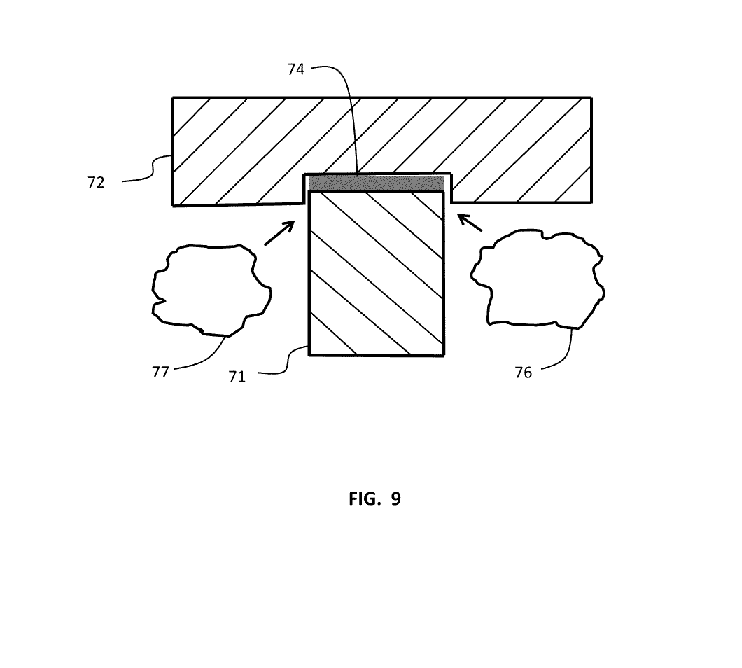

As seen in FIG. 9, the brazing material may bridge between two distinct atmospheres, both of which may present significant problems for prior brazing materials. On a first surface of the joint, the brazing material may need to be compatible with the processes occurring, and the environment 77 present, in the semiconductor processing chamber in which the joined ceramic assembly is to be used. The environment within a process chamber may include corrosive gasses, and also may include fluorine chemistries. On a second surface of the joint, the brazing material may need to be compatible with a different atmosphere 76, which may be an oxygenated atmosphere. Prior brazing materials used with ceramics have not been able to meet both of these criteria. For example, braze elements containing copper, silver, or gold may interfere with the lattice structure of a silicon wafer being processed in a chamber with the joined ceramic, and are thus not appropriate. However, in some cases, a surface of the brazed joint may see a high temperature, and an oxygenated atmosphere. The portion of the braze joint which would be exposed to this atmosphere will oxidize, and may oxidize inwardly into the joint, resulting in a failure of the hermiticity of the joint. In addition to structural attachment, the joint between joined ceramic pieces to be used in semiconductor manufacturing must be hermetic in many, if not most or all, uses.

A braze material which will be compatible with both of the types of atmospheres described above when they are seen on both sides across a joint in such a device is aluminum. Aluminum has a property of forming a self-limiting layer of oxidized aluminum. This layer is generally homogenous, and, once formed, prevents or significantly limits additional oxygen or other oxidizing chemistries (such a fluorine chemistries) penetrating to the base aluminum and continuing the oxidation process. In this way, there is an initial brief period of oxidation or corrosion of the aluminum, which is then substantially stopped or slowed by the oxide (or fluoride) layer which has been formed on the surface of the aluminum. The braze material may be in the form of a sheet, a powder, a thin film, or be of any other form factor suitable for the brazing processes described herein. For example, the brazing layer may be a sheet having a thickness ranging from 0.00019 inches to 0.011 inches or more. In some embodiments, the braze material may be a sheet having a thickness of approximately 0.0012 inches. In some embodiments, the braze material may be a sheet having a thickness of approximately 0.006 inches. Typically, alloying constituents (such as magnesium, for example) in aluminum are formed as precipitates in between the grain boundaries of the aluminum. While they can reduce the oxidation resistance of the aluminum bonding layer, typically these precipitates do not form contiguous pathways through the aluminum, and thereby do not allow penetration of the oxidizing agents through the full aluminum layer, and thus leaving intact the self-limiting oxide-layer characteristic of aluminum which provides its corrosion resistance. In the embodiments of using an aluminum alloy which contains constituents which can form precipitates, process parameters, including cooling protocols, would be adapted to minimize the precipitates in the grain boundary. For example, in one embodiment, the braze material may be aluminum having a purity of at least 99.5%. In some embodiments, a commercially available aluminum foil, which may have a purity of greater than 92%, may be used. In some embodiments, alloys are used. These alloys may include Al-5 w % Zr, Al-5w % Ti, commercial alloys #7005, #5083, and #7075. These alloys may be used with a temperature between 600 C and 850 C in some embodiments. These alloys may be used with a lower or higher temperature in some embodiments. In some embodiments, aluminum alloys in the 4000 series may be used as the braze material, which may allow for a braze temperature of as low as 570 C, for example.

The non-susceptibility of AlN to diffusion with aluminum under the conditions of processes according to embodiments of the present invention results in the preservation of the material properties, and the material identity, of the ceramic after the brazing step in the manufacturing of the plate and shaft assembly.

In some embodiments, the joining process is performed in a process chamber adapted to provide very low pressures. Joining processes according to embodiments of the present invention may require an absence of oxygen in order to achieve a hermetically sealed joint. In some embodiments, the process is performed at a pressure lower than 1×10E-4 Torr. In some embodiments, the process is performed at a pressure lower than 1×10E-5 Torr. In some embodiments, further oxygen removal is achieved with the placement of zirconium or titanium in the process chamber. For example, a zirconium inner chamber may be placed around the pieces which are to be joined.

In some embodiments, atmospheres other than vacuum may be used to achieve a hermetic seal. In some embodiments, argon (Ar) atmosphere may be used to achieve hermetic joints. In some embodiments, other noble gasses are used to achieve hermetic joints. In some embodiments, hydrogen (H2) atmosphere may be used to achieve hermetic joints.

The wetting and flow of the brazing layer may be sensitive to a variety of factors. The factors of concern include the type of layer deposited on the interface areas, the braze material composition, the ceramic composition, the chemical makeup of the atmosphere in the process chamber, especially the level of oxygen in the chamber during the joining process, the temperature, the time at temperature, the thickness of the braze material, the surface characteristics of the material to be joined, the geometry of the pieces to be joined, the physical pressure applied across the joint during the joining process, and/or the joint gap maintained during the joining process.

An example of a brazing method for joining together first and second ceramic pieces may include the steps of depositing a layer of metal, such as aluminum or an aluminum alloy, onto the joint interface areas of two ceramic pieces, bringing the first and second pieces together with a brazing layer selected from the group consisting of aluminum and an aluminum alloy disposed between the first and second ceramic pieces, heating the brazing layer to a temperature of at least the liquidus temperature of the brazing layer, and cooling the brazing layer to a temperature below its melting point so that the brazing layer hardens and creates a hermetic seal so as to join the first member to the second member. Various geometries of braze joints may be implemented according to methods described herein. The joining may be done using the same material for the brazing layer as is used for the metal deposition layer, which may be aluminum of greater than 99.8% AL.

A joining process according to some embodiments of the present invention may comprise some or all of the following steps. Two or more ceramic pieces are selected for joining. In some embodiments, a plurality of pieces may be joined using a plurality of joining layers in the same set of process steps, but for the sake of clarity of discussion two ceramic pieces joined with a single joining layer will be discussed herein. The ceramic pieces may be of aluminum nitride. The ceramic pieces may be of mono-crystalline or poly-crystalline aluminum nitride. Portions of each piece have been identified as the area of each piece which will be joined to the other. In an illustrative example, a portion of the bottom of a ceramic plate structure will be joined to the top of a ceramic hollow cylindrical structure. The joining material may be a brazing layer comprising aluminum. In some embodiments, the brazing layer may be a commercially available aluminum foil of >99% aluminum content. The brazing layer may consist of a plurality of layers of foil in some embodiments.

In some embodiments, the specific surface areas which will be joined will undergo a pre-metallization step. This pre-metallization step may be achieved by depositing aluminum or an aluminum alloy using a thin film sputtering technique.

Prior to joining, the two pieces may be fixtured relative to each other to maintain some positional control while in the process chamber. The fixturing may also aid in the application of an externally applied load to create contact pressure between the two pieces, and across the joint, during the application of temperature. A weight may be placed on top of the fixture pieces such that contact pressure is applied across the joint. The weight may be proportioned to the area of the brazing layer. In some embodiments, the contact pressure applied across the joint may be in the range of approximately 2-500 psi onto the joint contact areas. In some embodiments the contact pressure may be in the range of 2-40 psi. In some embodiments, minimal pressure may be used. The contact pressure used at this step is significantly lower than that seen in the joining step using hot pressing/sintering as seen in prior processes, which would use pressures in the range of 2000-3000 psi.

In embodiments using mesas or spheres as standoffs, the original thickness of the brazing layer prior to the application of heat may be slightly less than, equal to, or larger than the thickness of the final joint thickness maintained by the mesas or other devices. As the brazing layer temperature reaches and exceeds the liquidus temperature, pressure across the brazing layer between the pieces being joined may cause relative motion between the pieces until the mesas on a first piece contact an interface surface on a second piece. At that point, contact pressure across the joint will no longer be supplied by the external force (except as resistance to repulsive forces within the brazing layer, if any). The mesas, or other standoff technique such as ceramic spheres, may prevent the brazing layer from being forced out of the joint area prior to the full wetting of ceramic pieces, and may thus allow for better joining. In some embodiments, mesas are not used.

The fixtured assembly may then be placed in a process oven. The oven may be evacuated to a pressure of less than 5×10E-5 Torr. In some aspects, vacuum removes the residual oxygen. In some embodiments, a vacuum of lower than 1×10E-5 Torr is used. In some embodiments, the fixtured assembly is placed within a zirconium inner chamber which acts as an oxygen attractant, further reducing the residual oxygen which might have found its way towards the joint during processing. In some embodiments, the process oven is purged and re-filled with pure, dehydrated pure noble gas, such as argon gas, to remove the oxygen. In some embodiments, the process oven is purged and re-filled with purified hydrogen to remove the oxygen.

The fixture assembly is then subjected to increases in temperature, and a hold at the joining temperature. Upon initiating the heating cycle, the temperature may be raised slowly, for example 15 C per minute to 200 C and then 20 C per minute thereafter, to standardized temperatures, for example, 600 C and the joining temperature, and held at each temperature for a fixed dwell time to allow the vacuum to recover after heating, in order to minimize gradients and/or for other reasons. When the braze temperature has been reached, the temperature can be held for a time to effect the braze reaction. In some embodiments using a pre-metallization of one or more of the interface surfaces, the brazing temperature may be in the range of 600 C to 850 C. In an exemplary embodiment, the dwell temperature may be 700 C and the dwell time may be 1 minute. In another exemplary embodiment, the dwell temperature may be 750 C and the dwell time may be 1 minute. Upon achieving sufficient braze dwell time, the furnace may be cooled at a rate of 20 C per minute, or lower when the inherent furnace cooling rate is less, to room temperature. The furnace may be brought to atmospheric pressure, opened and the brazed assembly may be removed for inspection, characterization and/or evaluation.

Relative to aluminum brazing processes without a layer of aluminum deposited onto the joint interface areas, processes wherein the ceramic has had a thin layer of aluminum deposited thereon, such as with a thin film sputtering technique, yield hermetic joints at low temperatures and with very short dwell times at the braze temperature. The use of a deposited layer of aluminum on the interface surface may make the wetting of the surface comparatively much easier, and needing less energy, allowing for the use of lower temperatures and shortened dwell times to achieve a hermetic joint.

The brazing material will flow and allow for wetting of the surfaces of the ceramic materials being joined. When ceramic such as aluminum nitride is joined using aluminum brazing layers and in the presence of sufficiently low levels of oxygen and described herein, the joint is a hermetic brazed joint. This stands in contrast to the diffusion bonding seen in some prior ceramic joining processes.

In some embodiments, the pieces to be joined may be configured such that no pressure is placed across the brazing layer during brazing. For example, a post or shaft may be placed into a countersunk hole or recess in a mating piece. The countersink may be larger than the exterior dimension of the post or shaft. This may create an area around the post or shaft which then may be filled with aluminum, or an aluminum alloy. In this scenario, pressure placed between the two pieces in order to hold them during joining may not result in any pressure across the braze layer. Also, it may be possible to hold each piece in the preferred end position using fixturing such that little or no pressure is placed between the pieces at all.

Joined assemblies joined as described above result in pieces with hermetic sealing between the joined pieces. Such assemblies are then able to be used where atmosphere isolation is an important aspect in the use of the assemblies. Further, the portion of the joint which may be exposed to various atmospheres when the joined assemblies are later used in semi-conductor processing, for example, will not degrade in such atmospheres, nor will it contaminate the later semi-conductor processing.

Both hermetic and non-hermetic joints may join pieces strongly, in that significant force is needed to separate the pieces. However, the fact that a joint is strong is not determinative of whether the joint provides a hermetic seal. The ability to obtain hermetic joints may be related to the wetting of the joint. Wetting describes the ability or tendency of a liquid to spread over the surface of another material. If there is insufficient wetting in a brazed joint, there will be areas where there is no bonding. If there is enough non-wetted area, then gas may pass through the joint, causing a leak. Wetting may be affected by the pressure across the joint at different stages in the melting of the brazing material. The use of mesa standoffs, or other standoff device such as the insertion of ceramic spheres or powder particles of appropriate diameter, to limit the compression of the brazing layer beyond a certain minimum distance may enhance the wetting of the areas of the joint. Careful control of the atmosphere seen by the brazing element during the joining process may enhance the wetting of the areas of the joint. Pre-metallization of the joint interface areas, such as with thin film sputtering of aluminum as described above, may allow for full wetting at lower temperatures. In combination, careful control of the joint thickness, and careful control of the atmosphere used during the process, and deposition of a layer onto the ceramic prior to the brazing process step, may result in a complete wetting of the joint interface area that is not able to be achieved with other processes.

Acoustic imaging of the joint allows for viewing of the uniformity of the joint, and for determination of whether voids and/or passages exist in the joint. The resulting images of joints tested to be hermetic show uniform, voidless joints, while images of joints tested to be non-hermetic show voids, or large non-bonded areas, in the ceramic-braze layer interface area. In the examples seen in the acoustic images, rings have been bonded to a flat surface. The rings are typically 1.40 inches outer diameter, 1.183 inches interior diameter, with a joint interface area of approximately 0.44 square inches. The bonding of rings to a flat surface are exemplary of the joining of a hollow shaft to a plate, as may be seen in the assembly of a heater, for example.

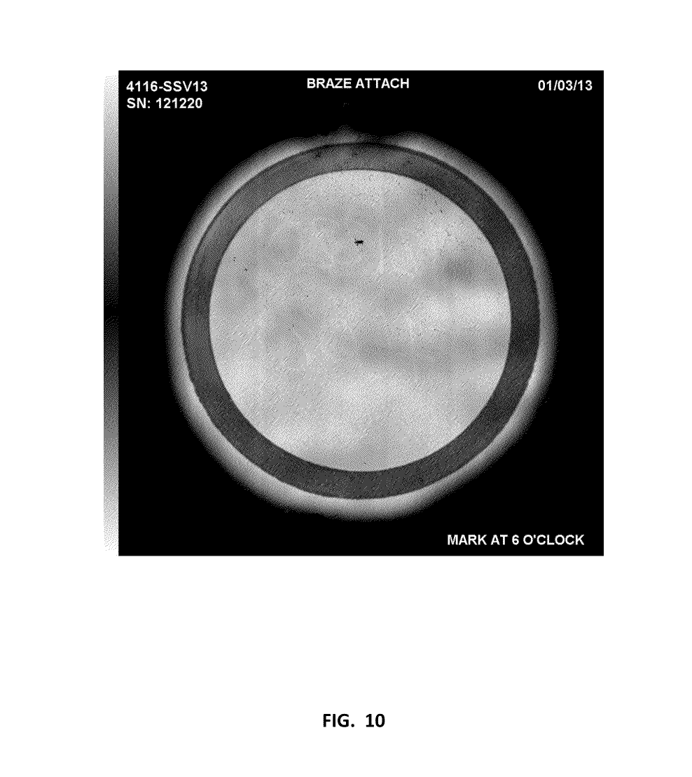

FIG. 10 is an image created using acoustic sensing of the joint integrity of a joint created according to the present invention. The joint was between two pieces of poly-crystalline aluminum nitride. The brazing layer material was of 0.003″ thickness of 99.8% aluminum foil. Each of the joint interface areas was metallized using a thin film deposition of 2 microns of aluminum. The joining temperature was 750 C held for 1 minute. The joining was done in a process chamber held at pressure lower than 6×10E-5 Torr. The joint thickness was maintained using 0.004″ diameter ZrO2 spheres. The image displays a solid dark color in locations where there is good wetting onto the ceramic. White/light areas would be indicative of a void at the joining surface of the ceramic. As seen, there is good and sufficient integrity of the joint. This joint was hermetic. Hermeticity was verified by having a vacuum leak rate of <1×10E-9 sccm He/sec; as verified by a standard commercially available mass spectrometer helium leak detector.

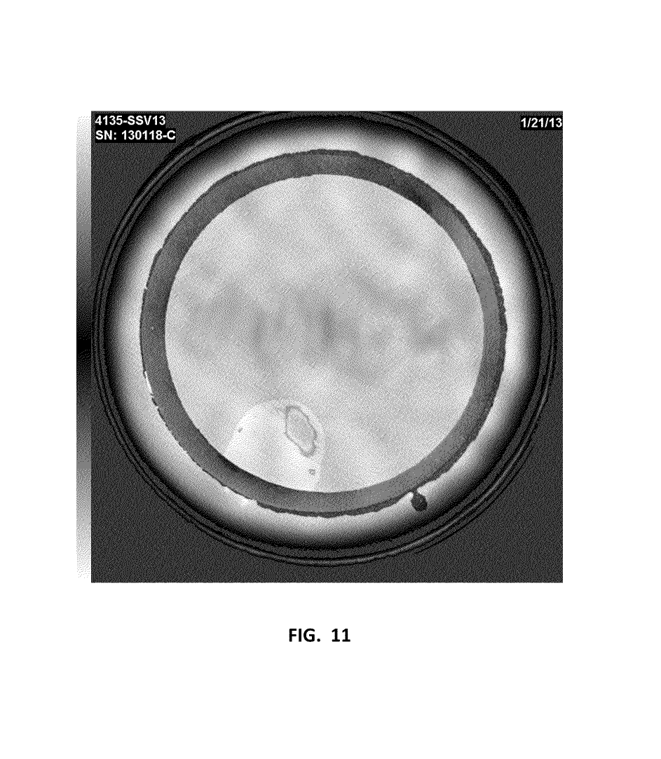

FIG. 11 is an image created using acoustic sensing of the joint integrity of a joint created according to the present invention. The joint was between two pieces of poly-crystalline aluminum nitride. The brazing layer material was of 0.003″ thickness of 99.8% aluminum foil. The joint interface area of the ring piece was metallized using a thin film deposition of 2 microns of aluminum. The joining temperature was 780 C held for 10 minutes. The joining was done in a process chamber held at pressure lower than 6×10E-5 Torr. The joint thickness was maintained using 0.004″ diameter ZrO2 spheres. The ring piece underwent an etching process prior to the deposition of the thin layer of aluminum. The image displays a solid dark color in locations where there is good wetting onto the ceramic. White/light areas would be indicative of a void at the joining surface of the ceramic. As seen, there is good and sufficient integrity of the joint. This joint was hermetic. Hermeticity was verified by having a vacuum leak rate of <1×10E-9 sccm He/sec; as verified by a standard commercially available mass spectrometer helium leak detector.

The hermeticity of the joint seen in FIG. 11 with only a single interface area being pre-metallized may be due to the effect on flow of the brazing material by just the single deposited Al layer. This effect on a first side of the joint may affect the totality of the brazing layer at temperature due to the relatively thin dimension of the braze layer.

In another exemplary embodiment, the interface area of both ceramic pieces to be joined were metallized using a thin film sputtering process. 2 microns of aluminum were deposited. The brazing layer material was 0.004 inch thick aluminum foil of >99.8% Al. The joint thickness was maintained using 0.004″ diameter ZrO2 spheres. The ring piece underwent an etching process prior to the deposition of the thin layer of aluminum. The joining was done in a process chamber held at pressure lower than 6×10E-5 Torr. The brazing temperature was 700 C. The joint was hermetic after brazing.

In some embodiments, brazing layer thicknesses of 0.003, 0.004, 0.005, 0.006, and 0.008 inches may be used with ceramic spheres of 0.004 inch diameter.

The presence of a significant amount of oxygen or nitrogen during the brazing process may create reactions which interfere with full wetting of the joint interface area, which in turn may result in a joint that is not hermetic. Without full wetting, non-wetted areas are introduced into the final joint, in the joint interface area. When sufficient contiguous non-wetted areas are introduced, the hermeticity of the joint is lost.

The presence of nitrogen may lead to the nitrogen reacting with the molten aluminum to form aluminum nitride, and this reaction formation may interfere with the wetting by the brazing material of the joint interface area, which may be a pre-metallized ceramic. Similarly, the presence of oxygen may lead to the oxygen reacting with the molten aluminum to form aluminum oxide, and this reaction formation may interfere with the wetting of the joint interface area. Using a vacuum atmosphere of pressure lower than 5×10-5 Torr has been shown to have removed enough oxygen and nitrogen to allow for fully robust wetting of the joint interface area, and hermetic joints. In some embodiments, use of higher pressures, including atmospheric pressure, but using non-oxidizing gasses such as hydrogen or pure noble gasses such as argon, for example, in the process chamber during the brazing step has also led to robust wetting of the joint interface area, and hermetic joints. In order to avoid the oxygen reaction referred to above, the amount of oxygen in the process chamber during the brazing process must be low enough such that the full wetting of the joint interface area is not adversely affected. In order to avoid the nitrogen reaction referred to above, the amount of nitrogen present in the process chamber during the brazing process must be low enough such that the full wetting of joint interface area is not adversely affected.

Another advantage of the joining method as described herein is that joints made according to some embodiments of the present invention may allow for the disassembly of components, if desired, to repair or replace one of those two components. Because the joining process did not modify the ceramic pieces by diffusion of a joining layer into the ceramic, the ceramic pieces are thus able to be re-used.

As evident from the above description, a wide variety of embodiments may be configured from the description given herein and additional advantages and modifications will readily occur to those skilled in the art. The invention in its broader aspects is, therefore, not limited to the specific details and illustrative examples shown and described. Accordingly, departures from such details may be made without departing from the spirit or scope of the applicant's general invention.

What is claimed is:

1. A method for the joining of ceramic materials, said method comprising the steps of:
depositing a thin layer of a first metal onto a first interface surface of a first ceramic piece;
depositing a thin layer of a first metal onto a first interface surface of a second ceramic piece;
placing a brazing element in a joint interface area between the first interface surface of said first ceramic piece and the first interface area of said second ceramic piece to create a joining pre-assembly;
heating said joining pre-assembly to a first joining temperature, thereby joining said first ceramic piece to said second ceramic piece while maintaining a minimum joint thickness of a first thickness.

2. The method of claim 1 wherein said first ceramic piece comprises aluminum nitride.

3. The method of claim 2 wherein said second ceramic piece comprises aluminum nitride.

4. The method of claim 3 wherein said brazing element comprises aluminum.

5. The method of claim 4 wherein said first metal comprises aluminum.

6. The method of claim 5 wherein said brazing element comprises more than 89% aluminum by weight.

7. The method of claim 5 wherein said brazing element comprises more than 99% aluminum by weight

8. The method of claim 1 further comprising the step of removing oxygen from said process chamber prior to the heating step.

9. The method of claim 4 further comprising the step of removing oxygen from said process chamber to the heating step.

10. The method of claim 5 further comprising the step of removing oxygen from said process chamber prior to the heating step.

11. The method of claim 8 wherein the step of removing oxygen from said process chamber comprises applying a pressure of lower than 1×10E-4 Torr to said process chamber.

12. The method of claim 10 wherein the step of removing oxygen from said process chamber comprises applying a pressure of lower than 1×10E-4 Torr to said process chamber.

13. The method of claim 11 wherein the step of removing oxygen from said process chamber comprises purging and re-filling the chamber with pure, dehydrated inert gas.

14. The method of claim 12 wherein the step of removing oxygen from said process chamber comprises purging and re-filling the chamber with pure, dehydrated inert gas.

15. The method of claim 11 wherein the step of removing oxygen from said process chamber comprises purging and re-filling the chamber with purified hydrogen.

16. The method of claim 12 wherein the step of removing oxygen from said process chamber comprises purging and re-filling the chamber with purified hydrogen.

17. The method of claim 12 wherein said step of heating said joining pre-assembly to a first joining temperature comprises heating said joining pre-assembly to a temperature between 600 C and 800 C.

18. The method of claim 14 wherein said step of heating said joining pre-assembly to a first joining temperature comprises heating said joining pre-assembly to a temperature between 600 C and 850 C.

19. The method of claim 14 wherein said step of heating said joining pre-assembly to a first joining temperature comprises heating said joining pre-assembly to a temperature between 600 C and 1200 C.

20. The method of claim 16 wherein said step of heating said joining pre-assembly to a first joining temperature comprises heating said joining pre-assembly to a temperature between 600 C and 850 C.

21. The method of claim 17 wherein said step of heating said joining pre-assembly to a first joining temperature comprises heating said joining pre-assembly for a duration of between 1 second and 1 hour.

22. A method for the joining of ceramic materials, said method comprising the steps of:
depositing a thin layer of a first metal onto a first interface surface of a first ceramic piece;
depositing a thin layer of a first metal onto a first interface surface of a second ceramic piece;
placing a brazing element in a joint interface area between the first interface surface of said first ceramic piece and the first interface area of said second ceramic piece to create a joining pre-assembly;
placing the components of said joining pre-assembly into a process chamber;
removing oxygen from said process chamber; and
heating said joining pre-assembly to a first joining temperature, thereby joining said first ceramic piece said second ceramic with a hermetically sealed joint.

23. The method of claim 22 wherein said first ceramic piece comprises aluminum nitride.

24. The method of claim 23 wherein said second ceramic piece comprises aluminum nitride.

25. The method of claim 24 wherein said brazing element comprises aluminum.

26. The method of claim 4 wherein said first metal comprises aluminum.

27. The method of claim 26 wherein said brazing element comprises more than 89% aluminum by weight.

28. The method of claim 26 wherein said brazing element comprises more than 99% aluminum by weight

29. The method of claim 22 further comprising the step of removing oxygen from said process chamber.

30. The method of claim 25 further comprising the step of removing oxygen from said process chamber.

31. The method of claim 26 further comprising the step of removing oxygen from said process chamber.

32. The method of claim 30 wherein the step of removing oxygen from said process chamber comprises applying a pressure of lower than 1×10E-4 Torr to said process chamber.

33. The method of claim 31 wherein the step of removing oxygen from said process chamber comprises applying a pressure of lower than 1×10E-4 Torr to said process chamber.

34. The method of claim 30 wherein the step of removing oxygen from said process chamber comprises purging and re-filling the chamber with pure, dehydrated inert gas.

35. The method of claim 31 wherein the step of removing oxygen from said process chamber comprises purging and re-filling the chamber with pure, dehydrated inert gas.

36. The method of claim 30 wherein the step of removing oxygen from said process chamber comprises purging and re-filling the chamber with purified hydrogen.

37. The method of claim 31 wherein the step of removing oxygen from said process chamber comprises purging and re-filling the chamber with purified hydrogen.

38. The method of claim 32 wherein said step of heating said joining pre-assembly to a first joining temperature comprises heating said joining pre-assembly to a temperature between 600 C and 850 C.

39. The method of claim 33 wherein said step of heating said joining pre-assembly to a first joining temperature comprises heating said joining pre-assembly to a temperature between 600 C and 850 C.

40. A method for the joining of ceramic materials, said method comprising the steps of:
depositing a thin layer of a first metal onto a first interface surface of a first ceramic piece;
placing a brazing element in a joint interface area between the first interface surface of said first ceramic piece and a first interface area of a second ceramic piece to create a joining pre-assembly;
heating said joining pre-assembly to a first joining temperature, thereby joining said first ceramic piece to said second ceramic piece while maintaining a minimum joint thickness of a first thickness.

41. The method of claim 40 wherein said first ceramic piece comprises aluminum nitride.

42. The method of claim 41 wherein said second ceramic piece comprises aluminum nitride.

43. The method of claim 42 wherein said brazing element comprises aluminum.

44. The method of claim 43 wherein said first metal comprises aluminum.

45. The method of claim 40 further comprising the step of removing oxygen from said process chamber prior to the heating step.

46. The method of claim 44 further comprising the step of removing oxygen from said process chamber prior to the heating step.

47. The method of claim 45 wherein said step of heating said joining pre-assembly to a first joining temperature comprises heating said joining pre-assembly to a temperature between 600 C and 850 C.

48. The method of claim 46 wherein said step of heating said joining pre-assembly to a first joining temperature comprises heating said joining pre-assembly to a temperature between 600 C and 850 C.
